(19) United States
(12) Patent Application Publication
(10) Pub. No.: US 2016/0082486 A1
(43) Pub. Date: Mar. 24, 2016

(54) VALVE HOUSING

(71) Applicant: Buerkert Werke GmbH, Ingelfingen (DE)

(72) Inventors: Klaus-Guenther Beck, Kuenzelsau (DE); Hendrik Faustmann, Oehringen (DE)

(73) Assignee: Buerkert Werke GmbH, Ingelfingen (DE)

(21) Appl. No.: 14/850,861

(22) Filed: Sep. 10, 2015

(30) Foreign Application Priority Data
Sep. 22, 2014 (DE) 102014113655.1

(51) Int. Cl. B08B 7/02

(52) U.S. Cl. CPC B08B 7/028

(57) ABSTRACT

There is described a valve housing which includes an inlet, an outlet and a vibration generator. The vibration generator is a surface wave chip which is mounted flat on the valve housing and is able to couple a surface wave into the valve housing.

### CROSS REFERENCE TO RELATED APPLICATION

The present application claims priority from pending German Patent Application No. 10 2014 113 655.1, filed Sep. 22, 2014, which is incorporated herein by reference.

### FIELD

This invention relates to a valve housing with an inlet, an outlet and a vibration generator.

### BACKGROUND

From the prior art, valves are known which are used for controlling a fluid stream. These valves include a valve housing which has an inlet and an outlet so that a medium to be controlled can flow through the valve via the inlet and can then leave the valve via the outlet.

During the operation, residues and deposits of the medium can occur in the valve housing. In general, residues and deposits are not desired as mixing can occur when the media are changed. This applies in particular when the valves are used in connection with foodstuffs and pharmaceuticals.

It therefore is known from the prior art to form the valve housings of the valves such that they are self-draining. The introduced medium is meant to be drained automatically via the inlet or the outlet, so that no residues of the medium remain in the valve body. However, it can almost not be avoided that at least small amounts of residues of the medium remain in the valve body.

The self-draining usually depends on the mounting position of the valve. For example, the outlet is arranged at the lowest point of the valve so that the medium flows to the outlet due to gravity. However, as soon as the valve is not installed in its intended mounting position or with too little inclination, self-draining is impaired.

In addition, the self-draining known from the prior art depends on the quality of the surfaces forming the flow channel, as a high surface quality results in a better flow behavior. A high surface quality, however, only can be realized by manufacturing processes which involve high costs.

Furthermore, it is known to provide the surfaces with coatings which for example have liquid-repellent effects, in order to improve the self-draining. However, this has the disadvantage that the coatings can be detached and contaminate the medium to be controlled by the valve.

Furthermore, it is known from the prior art to provide the valve with walls as steep as possible so that the residues overcome the static friction more easily and start to flow more easily. Due to the available limited installation space, however, this only is possible to a limited extent.

To support self-draining and guarantee the cleanness of the valve, it is known from the prior art to additionally clean the valve housing. For this purpose, the valve housing is rinsed so that the residues are washed away. It is disadvantageous that rests of the cleaning or rinsing medium then remain in the valve body.

It has turned out, however, that simple rinsing is not sufficient to achieve a reliable cleaning of the valve housing. To improve cleaning, it therefore is provided in the prior art to detach the deposits already present in the valve body by means of ultrasonic waves so that the detached deposits can be flushed away during rinsing.

The use of ultrasonic waves, however, only represents a slight improvement, as the detached deposits still can remain in the valve housing as a consequence from the geometry of the valve housing. Furthermore, the valve housing must be rinsed in order to flush the deposits detached by the ultrasonic waves out of the valve housing.

It is the object of the invention to provide a valve housing which is easier to clean with simple means and has an improved self-draining.

### BRIEF DESCRIPTION

According to the invention, this object is solved by a valve housing with an inlet, an outlet and a vibration generator, wherein the vibration generator is a surface wave chip which is mounted flat on the valve housing and is able to couple a surface wave into the valve housing.

The idea underlying the invention is to put the valve housing into vibration such that surface waves propagate on the valve housing, which selectively transport media residues in the valve housing. A surface wave chip is a vibration generator which can be put into vibration, wherein the surface wave chip transmits the vibration to an adjoining material, in particular a metal or a plastic material, such that surface waves are formed on the surface of the material. Surface waves are characterized in that they have a defined direction of propagation along the surface so that a defined transport path is specified for the residues along the surface of the material put into vibration. By the surface wave chip an active or induced self-draining is created which is reliable. In addition, the valve housing need not be rinsed subsequently, as is the case when cleaning with ultrasonic waves. The surface wave chip can be activated after each passage of the medium in order to prevent the risk of residues of the medium drying up. This means that the valve body is cleaned before deposits occur at all. In addition, deposits that have occurred also can be detached by means of the surface waves and then be carried away. Due to the active self-draining, a reliable self-draining also can be provided at small angles of inclination within the valve housing. Due to the induced self-draining of the valve housing, subsequent cleaning can be omitted or be carried out much more rarely. Moreover, the surface waves do not cause any audible noises.

According to one embodiment of the invention the surface wave chip is mounted on an outside of the valve housing. The medium introduced into the valve housing is flowing along an inside of the valve housing opposite to the outside. The surface wave chip mounted on the outside thus is protected against the medium. The surface wave chip puts the valve housing into vibration at least in the region of the surface wave chip so that on the inside of the valve housing the surface waves are formed, with which residues and deposits on the inside are avoided or carried away.

According to another embodiment of the invention the surface wave chip is mounted in a receptacle in the wall of the valve housing. It thereby is ensured that the surface wave chip is arranged in direct vicinity of the inside of the valve housing, on which the surface waves are to be formed. This is advantageous in particular in valve housings which are formed of a thick-walled material, for example a cast or forged valve housing.

In particular, the surface wave chip is able to generate and emit surface acoustic waves, so-called SAW waves.

In one embodiment of the invention, the surface wave chip is able to generate Lamb waves. Lamb waves are vibrations of a flat body in which deflections occur both vertically and in direction of propagation. Accordingly, Lamb waves are mixed pressure and shear waves. The walls of the valve housing are to be regarded as substantially flat bodies, even if they are formed macroscopically round or oval. As reference quantity, the wavelength of the generated surface waves is important. Lamb waves are particularly suitable for applications in thin-walled bodies.

Alternatively, the surface wave chip is able to generate Rayleigh waves. Rayleigh waves are particularly favorable for applications in thick-walled bodies. A Rayleigh wave also is a surface acoustic wave. The Rayleigh wave includes rolling movements whereby the inside of the valve housing both moves up and down and to and fro in direction of propagation of the wave. The Rayleigh wave can couple into residues in the valve housing at a Rayleigh angle whereby the acoustic energy is absorbed by the residues, which results in a corresponding impulse transfer.

The directed propagation of the Rayleigh or Lamb wave results in a directed transport of the residues along the inner surface of the valve housing so that the residues selectively are carried away and no deposits can be formed.

The surface wave chip in particular can be a piezo element. Piezo elements have a low energy consumption and can be produced at low cost. In addition, piezo elements have a long service life. The piezo element is electrically excited so that it is put into vibration which is transmitted to the valve housing. The surface waves thereby are coupled into the valve housing. In particular, the surface wave chip can be an interdigital converter which also is known as interdigital transducer.

Furthermore, the surface wave chip can be designed as sensor which receives surface waves. It thereby is possible that the flow rate through the valve housing can be measured. This is advantageous when the valve must be controlled precisely. A separate flowmeter is not necessary in this embodiment. Alternatively and/or in addition, the surface wave chip can monitor the valve stroke for diagnostic purposes. For this purpose, the surface wave chip can measure the time which passes until the surface wave is reflected by a thrust piece or a membrane of the valve drive.

According to another embodiment, several surface wave chips are mounted on the valve housing. The residues thereby can be carried away in a focused manner. Furthermore, several surfaces can be cleaned selectively via the plurality of surface wave chips. In general, the liquid removal in the valve housing is thereby improved. Furthermore, a particular surface wave chip can act as a sensor which for example is arranged on a web in the valve housing, in order to at the same time monitor the valve stroke or measure the flow rate.

In particular, the surface wave chip is oriented such that the direction of propagation of the surface waves generated by the chip, points to the outlet or to the inlet. It thereby is ensured that the residues or the detached deposits are transported to the outlet or to the inlet so that they exit from the valve housing, whereby an optimum self-draining and hence a complete cleaning of the valve housing is achieved.

Furthermore, the valve housing can include a plastically deformed tube portion. This plastically deformed tube portion can form the web of the valve housing, with which the valve element or a membrane cooperates in order to control the flow through the valve. Preferably, the surface wave chip is arranged in the region of the plastically deformed portion as this region is the most critical point of the valve with respect to the deposits to be avoided.

In particular, the vibration generator is formed such that the surface waves have a wave amplitude and/or wave frequency which results in resonances of the valve housing being generated. In this way, a particularly good self-draining is achieved as the generated vibration amplitudes of the valve housing are optimal for achieving an optimum energy input in order to remove residues and deposits.

### BRIEF DESCRIPTION OF THE DRAWINGS

Further advantages and properties of the invention can be taken from the following description and the drawings to which reference is made. In the drawings:

FIG. 1 shows a perspective view of a valve housing according to the invention.

FIG. 2 shows a further perspective view of the valve housing according to the invention as shown in FIG. 1.

FIG. 3 shows a further perspective view of the valve housing according to the invention as shown in FIGS. 1 and 2.

FIG. 4 shows a cross-sectional view of the valve housing according to the invention as shown in FIGS. 1 to 3.

FIG. 5 shows a perspective view of the valve housing according to the invention as shown in FIGS. 1 to 4 with provided electronics.

FIG. 6 shows a perspective view of the valve housing according to the invention as shown in FIGS. 1 to 5 with a cladding mounted on the valve housing.

FIG. 7 shows a top view of a second embodiment of the valve housing according to the invention.

FIG. 8 shows a sectional representation of a third embodiment of the valve housing according to the invention.

FIG. 9 shows a perspective view of a fourth embodiment of the valve housing according to the invention.

FIG. 10 shows a sectional representation of the valve housing of FIG. 9.

FIG. 11 shows a detail view of a vibration generator.

### DETAILED DESCRIPTION

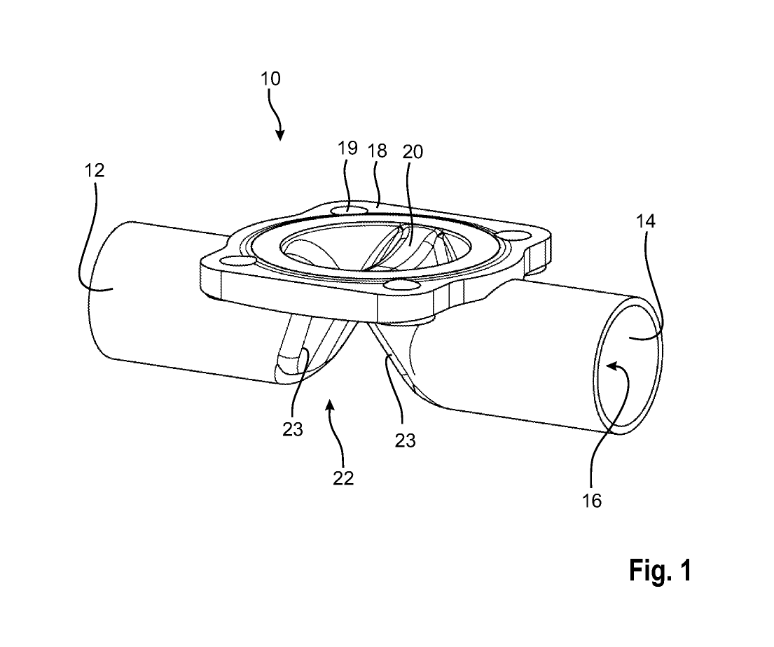

FIGS. 1 to 6 show a valve housing 10 according to a first embodiment in various perspectives and representations.

The valve housing 10 includes an inlet 12 and an outlet 14, between which a flow channel 16 is provided through which a medium to be controlled can flow. Via the inlet 12 a medium to be controlled is supplied to the valve housing 10, which after flowing through the flow channel 16 is drained via the outlet 14.

The valve housing 10 furthermore includes a connecting region 18 to which a non-illustrated valve drive can be mounted, in order to form a valve. For this purpose, the connecting region 18 includes four bores 19 which are arranged in corners of the connecting region 18 and through which fastening means such as screws can extend.

Alternatively, the valve drive can be connected with the valve housing 10 by a clip or thread connection.

The valve housing 10 further has a web 20 which is arranged in the flow channel 16 and cooperates with a non-illustrated valve element or a non-illustrated membrane, in order to block or clear the flow path through the flow channel 16. When cooperating with the membrane or the valve element, the web 20 forms a so-called sealing web.

The web 20 is arranged on a portion 22 of the valve housing 10. The portion 22 in particular can be a plastically deformed portion which for example has been formed when manufacturing the valve housing 10 proceeding from a tube portion by means of internal high-pressure forming and introduction of a die.

This results in the web 20 from which two steep opposed flanks 23 extend, so that the portion 22 is a substantially V-shaped indentation of the valve housing 10, which also is referred to as pocket. The flanks 23 correspondingly also are referred to as sides of the pocket.

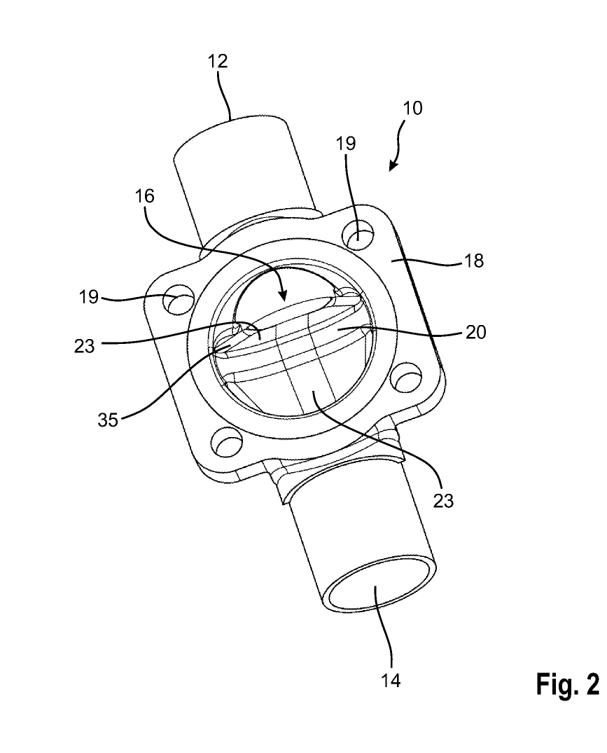

FIG. 2 shows a draining chute 25 via which medium gets from the inlet 12 via the web 20 to the outlet 14. In this draining chute 25, residues often are left undesirably. According to the invention, a vibration generator 24 is being employed, which effects the self-draining of the valve housing 10.

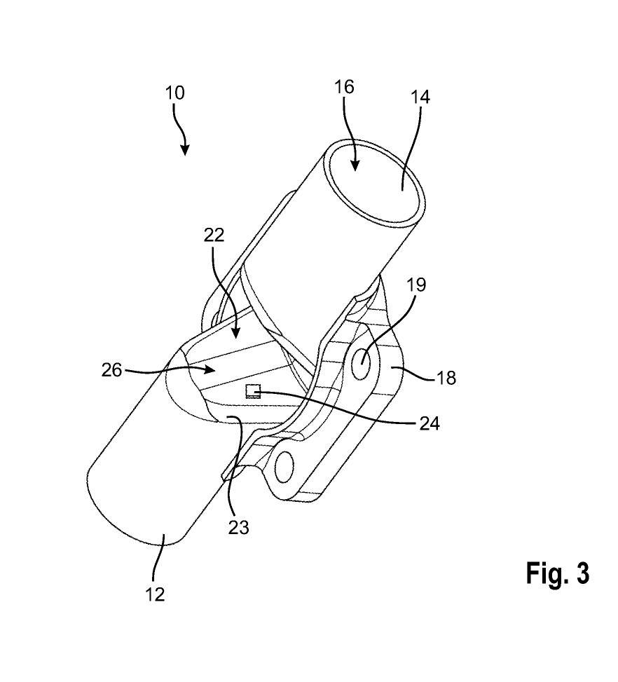

A vibration generator 24 (FIG. 3) is mounted on the valve housing 10, which is formed as surface wave chip and is attached flat to the valve housing 10, whereby it has a large effective surface with the valve housing 10. In general, the vibration generator 24 is arranged on an outside 26 of the valve housing 10. In the illustrated embodiment, the vibration generator 24 is provided on the plastically deformed portion 22, in particular on one of the two flanks 23.

The vibration generator 24 can be a piezo element which is excited electronically in order to be set into a vibrating condition. The piezo element for example can be formed as interdigital transducer.

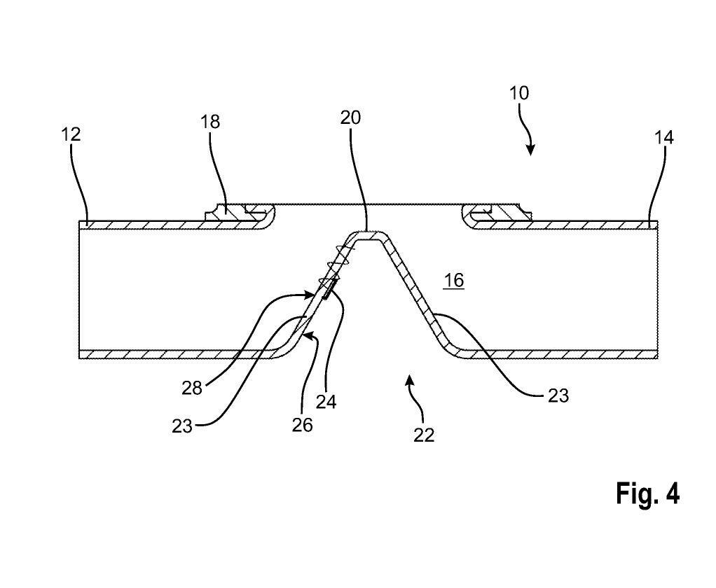

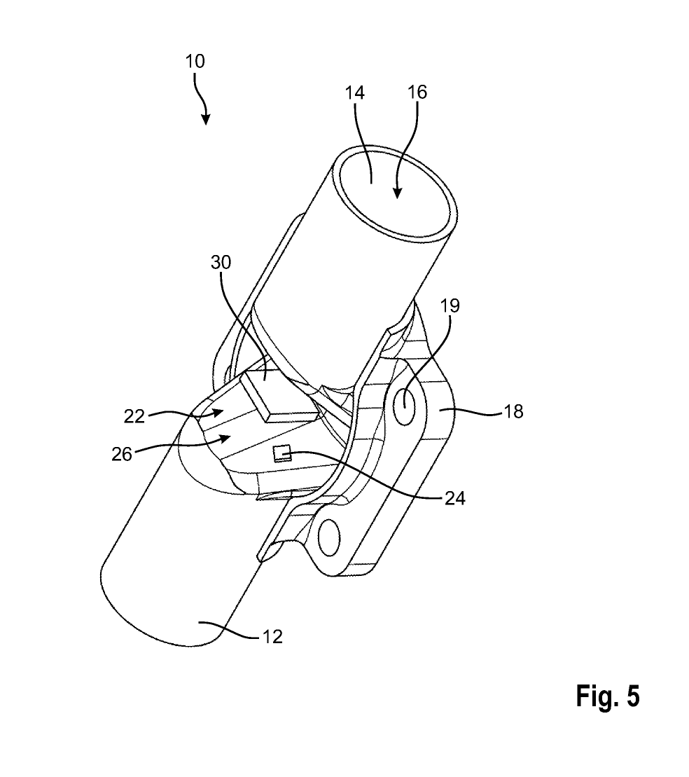

In general, the vibration generator 24 is electrically connected with a control and evaluation unit 30 (FIG. 5) which excites the vibration generator 24 so that it vibrates. The vibration of the vibration generator 24 is transmitted to the valve housing 10 which thereby likewise is put into vibration such that surface waves are formed in the valve housing 10. The vibration generator 24 accordingly couples surface waves into the valve housing 10, which surface waves are schematically shown in FIG. 4.

The vibration generator 24 formed as surface wave chip in particular can be a surface wave chip which generates Lamb waves or Rayleigh waves.

In general, the generated surface waves are vibrations which have a defined direction of propagation. The surface waves correspondingly propagate on an inside 28 of the valve housing 10 whereby existing residues of the medium flowing through the flow channel 16 are carried away selectively (FIG. 4). Furthermore, the surface waves can detach already existing deposits on the inside 28 and likewise selectively carry away the detached deposits.

In the illustrated embodiment, the vibration generator 24 therefore is arranged in the region of the portion 22 such that the surface waves coupled by the same into the valve housing 10 have a direction of propagation which points to the outlet 14 of the valve housing 10. It thereby is ensured that the residues transported by the surface waves are selectively guided to the outlet 14 in order to there leave the valve housing 10. Mixing with a subsequently introduced medium or drying up of the deposits thereby is avoided.

In general, the vibration generator 24 also can be positioned such that the surface waves are directed to the inlet so that the residues leave the valve housing 10 via the inlet.

Due to the active actuation of the vibration generator 24, an active or induced self-draining of the valve housing 10 is realized, which is particularly effective.

To ensure that surface waves effectively propagate on the inside 28 of the valve housing 10, the valve housing 10 preferably is formed thin-walled. The walls can have a thickness of 0.2 to 5 mm, in particular of 0.5 to 3 mm.

The control and evaluation unit 30 likewise can be arranged on the outside 26 of the valve housing 10, in particular on the outside 26 of the web 20, so that it is located in the plastically deformed portion 22. A compact design of the valve housing 10 along with the control and evaluation unit 30 thereby is created, as the control and evaluation unit 30 is arranged exactly in the pocket and thus does not protrude.

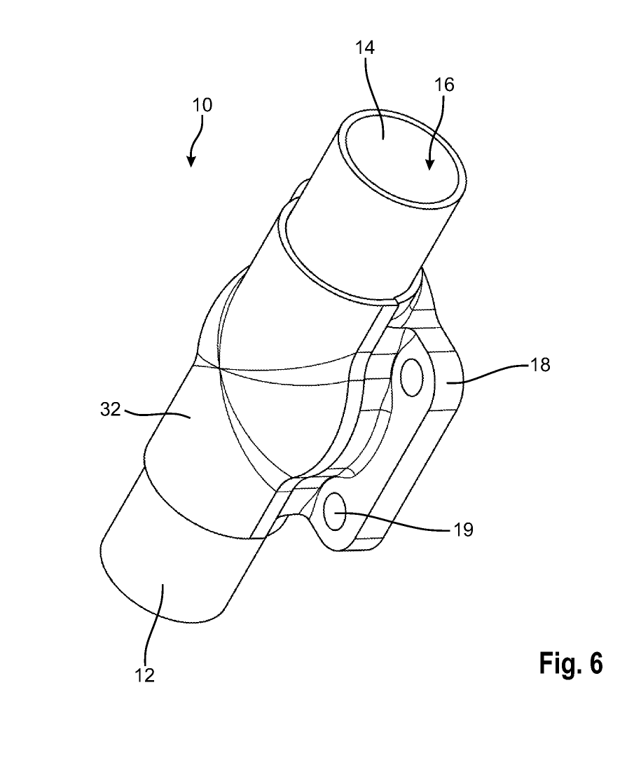

Due to the compact formation of the valve housing 10 with the control and evaluation unit 30 arranged thereon, the control and evaluation unit 30 can be enclosed by a cladding element 32 which surrounds the plastically deformed portion 22 (FIG. 6). The cladding element 32 can be firmly connected with the valve housing 10, for example be welded to the same. In general, this provides a mechanical protection of the control and evaluation unit 30 and of the vibration generator 24 likewise provided on the plastically deformed portion 22.

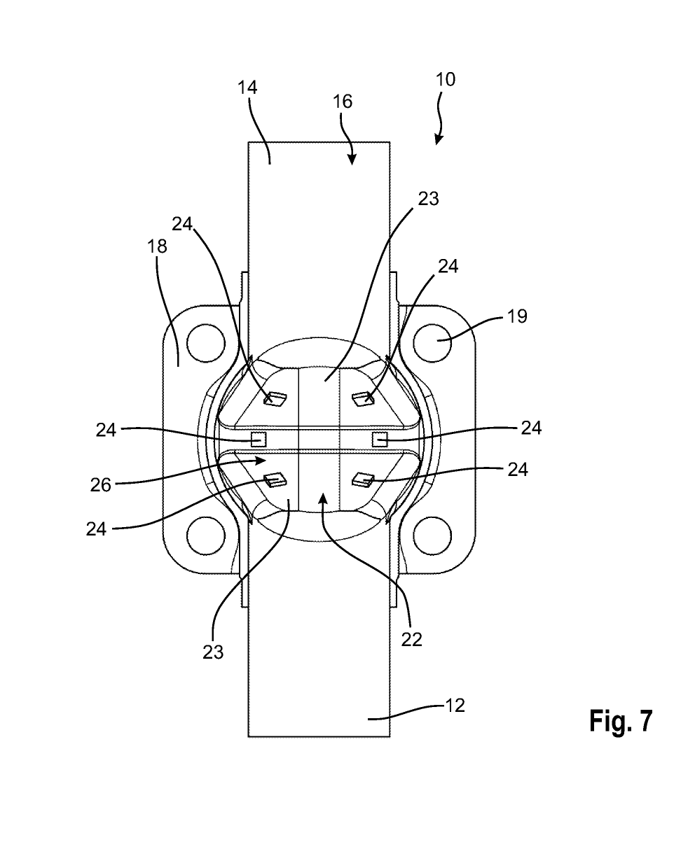

A second embodiment of the valve housing 10 is shown in FIG. 7, wherein the second embodiment differs from the first embodiment in that several vibration generators 24 are arranged on the outside 26 of the valve housing 10 in the region of the plastically deformed portion 22.

In the embodiment shown by way of example, a total of six vibration generators 24 are arranged in the portion 22, with two vibration generators 24 being arranged directly on the outside 26 of the web 20.

The vibration generators 24 arranged on the outside 26 of the web 20 can be surface wave chips which are designed as sensors and are formed to receive the surface waves.

These vibration generators 24 serve for measuring the time which the surface waves coupled in by the remaining vibration generators 24 need to be reflected by a valve element or a membrane of the non-illustrated valve drive. It thereby is possible to monitor the valve stroke with the two vibration generators 24.

In general, it is possible to focus the surface waves because of the several vibration generators 24 acting as actuators, so that the energy proceeding from the surface waves can selectively be passed to constrictions of the valve housing 10, in order to provide for the best possible cleaning of the valve housing 10.

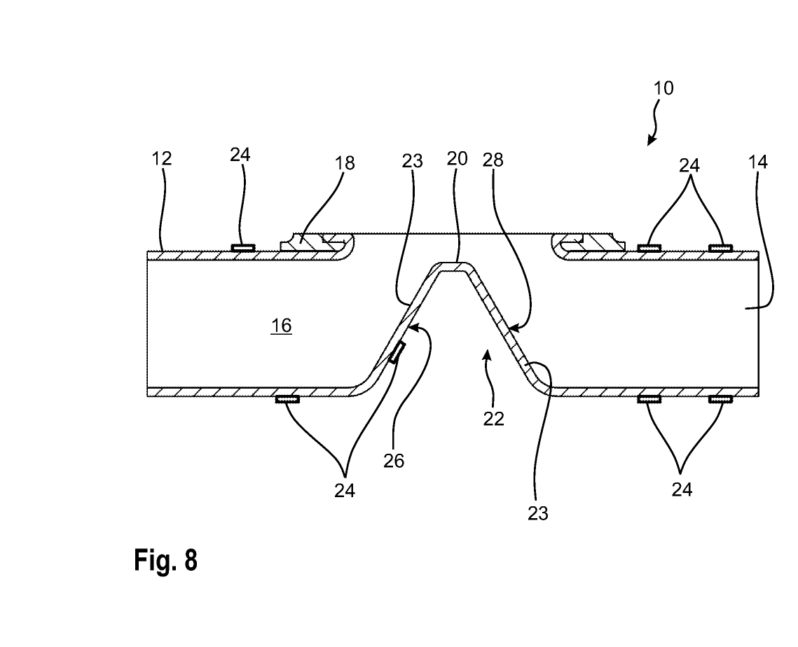

A third embodiment is shown in FIG. 8, in which additional vibration generators 24 are provided in the region of the inlet 12 and the outlet 14.

These vibration generators 24 likewise can be surface wave chips which are designed as sensors. With these vibration generators 24, the flow rate for example can be determined qualitatively. In addition, it can thus be checked whether the induced or active self-draining works and residues are being carried away.

Alternatively, the further vibration generators 24 can serve for controlling and focusing the direction of propagation of the surface waves coupled in.

All vibration generators 24 are coupled with the control and evaluation unit 30 so that the data acquired by the same, if the vibration generators 24 are formed as sensors, are transmitted to the control and evaluation unit 30 which evaluates the data.

In particular, the control and evaluation unit 30 can control the vibration generators 24 formed as actuators in dependence on the data acquired by the vibration generators 24 formed as sensors.

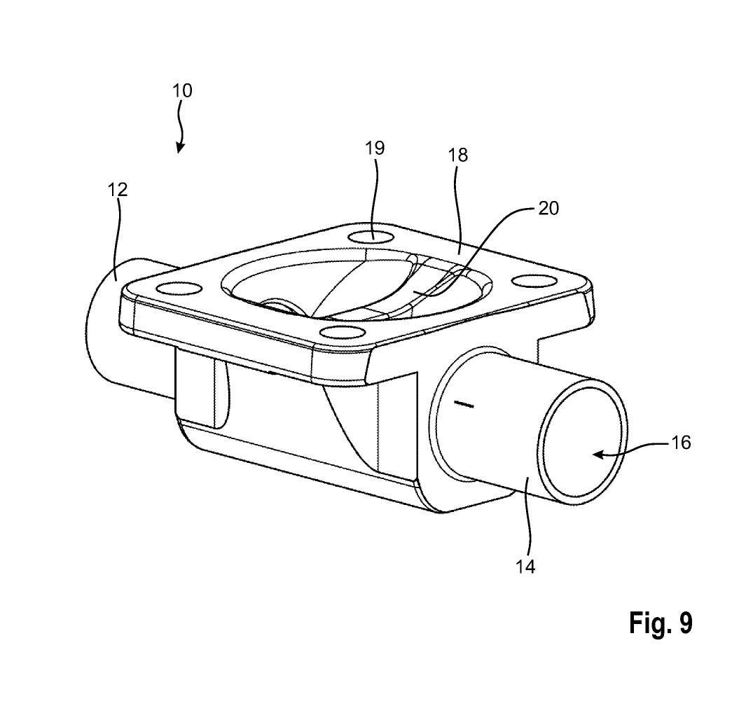

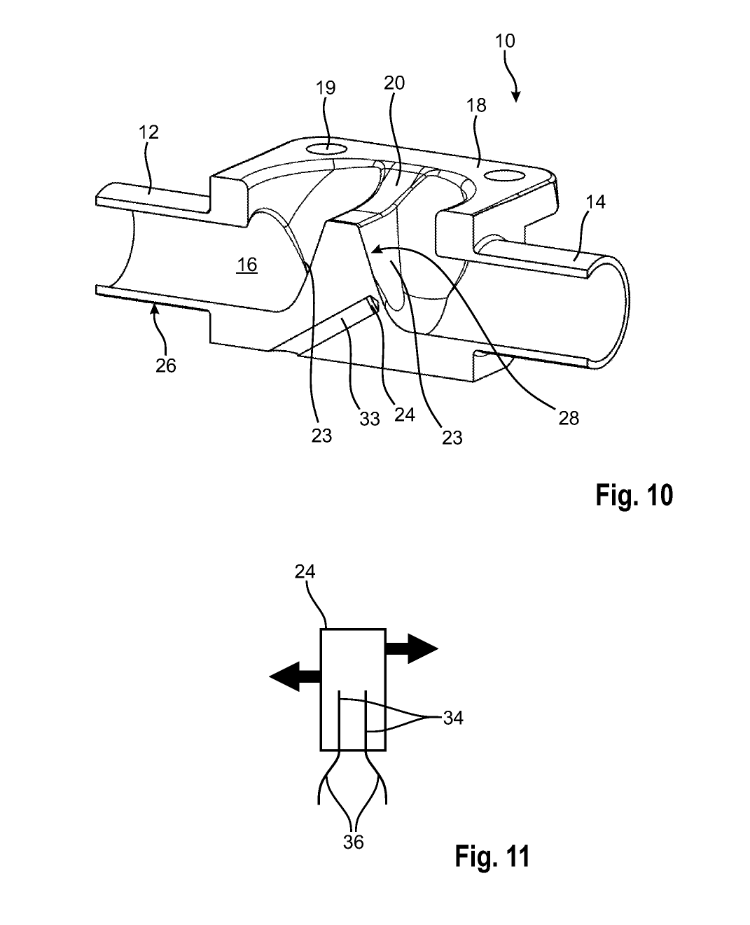

FIGS. 9 and 10 show a fourth embodiment of the valve housing 10, in which the valve housing 10 is formed with a greater wall thickness. For example, the valve housing 10 can be a solid cast or forged valve housing.

The valve housing 10 likewise includes a web 20 which is formed solid. Nevertheless, steep flanks 23 formed on the inside 28 of the valve housing 10 extend from the web 20.

The valve housing 10 furthermore includes a receptacle 33 in a wall of the valve housing 10, in which the vibration generator 24 is accommodated. It thereby is ensured that the vibration generator 24 is arranged close to the inside 28 of the valve housing 10 in order to transmit the vibrations proceeding from the same to the inside 28 of the valve housing 10. On the inside 28 of the valve housing 10, surface waves thus propagate, which transport possible residues or detach and carry away deposits.

With the valve housing 10 according to the fourth embodiment it thus is possible to form surface waves on the inside 28 of thick-walled valve housings 10 without having to place the vibration generator 24 on the inside 28, so that it does not get in contact with the medium.

The receptacle 33 for example can be formed by a bore in the valve housing 10, which extends from the outside 26 of the valve housing 10 to the inside 28. The remaining wall thickness between the bottom of the bore and the inside 28 is a few millimeters.

A vibration generator 24 is shown in detail in FIG. 11. In the embodiment shown, the vibration generator 24 includes two electrodes 34 which each are contacted with a cable 36 that couples the vibration generator 24 with the control and evaluation unit 30.

The direction of propagation of the surface waves generated by the vibration generator 24 is represented by the arrows. FIG. 11 shows that the surface waves propagate perpendicularly to the orientation of the electrodes 34.

In a vibration generator 24, the electrodes 34 cannot be seen from outside and only are shown in this representation for a better understanding. However, their orientation results from the way the cables 36 are oriented.

The vibration generators 24 for example can be operated with a peak voltage of about 100 V.

With the valve housing 10 according to the invention, it generally is possible to completely liberate the valve housing 10 from residues and/or deposits. Due to the surface waves coupled in, which are generated by the vibration generator 24 formed as surface wave chip, targeted movements of residues are possible. An active or induced self-draining of the valve housing 10 thereby is created, which is particularly effective.

In particular, the surface waves can be generated each time the medium is drained from the valve housing 10 so that an automatic cleaning of the valve housing 10 is performed.

1. A valve housing with an inlet, an outlet and a vibration generator, characterized in that the vibration generator is a surface wave chip which is mounted flat on the valve housing and is able to couple a surface wave into the valve housing.

2. The valve housing according to claim 1, characterized in that the surface wave chip is mounted on an outside of the valve housing.

3. The valve housing according to claim 1, characterized in that the surface wave chip is mounted in a receptacle in the wall of the valve housing.

4. The valve housing according to claim 1, characterized in that the surface wave chip generates Lamb waves.

5. The valve housing according to claim 1, characterized in that the surface wave chip generates Rayleigh waves.

6. The valve housing according to claim 1, characterized in that the surface wave chip is a piezo element.

7. The valve housing according to claim 1, characterized in that the surface wave chip is designed as sensor.

8. The valve housing according to claim 1, characterized in that several surface wave chips are mounted on the valve housing.

9. The valve housing according to claim 1, characterized in that the surface wave chip is oriented such that the direction of propagation of the surface waves generated by the chip points to the inlet and/or to the outlet.

10. The valve housing according to claim 1, characterized in that the valve housing includes a plastically deformed tube portion.

11. The valve housing according to claim 1, characterized in that the vibration generator is formed such that the surface waves have a wave amplitude and/or wave frequency with which resonances of the valve housing are being generated.
